(19) United States
(12) Patent Application Publication
(10) Pub. No.: US 2026/0055873 A1
(43) Pub. Date: Feb. 26, 2026

(54) COOLING DEVICE, LIGHTING DEVICE FOR A MOTOR VEHICLE, AND MOTOR VEHICLE

(71) Applicant: AUDI AG, Ingolstadt (DE)

(72) Inventors: Markus THURMEIER, Adlkofen (DE); Francisco TRIGUEROS MORERA DE LA VALL, München (DE); Christian LENGYEL, Neckarsulm (DE)

(21) Appl. No.: 19/300,195

(22) Filed: Aug. 14, 2025

(30) Foreign Application Priority Data
Aug. 20, 2024 (DE) 102024123753.8

(51) Int. Cl. F21S 45/47; F21S 41/141; F21V 29/51; F28F 3/02

(52) U.S. Cl. CPC F21S 45/47; F21S 41/141; F21V 29/51; F28F 3/02; F28F 2215/06

(57) ABSTRACT

A cooling device is disclosed, and may include a heat sink having at least one heat-conducting surface and at least two cooling fins projecting from the heat sink on a side of the heat sink facing away from a heat-conducting surface of the at least one heat-conducting surface. The heat sink may be configured to be coupled to a heat source in a heat-conducting manner. Each cooling fin of the at least two cooling fins may include at least one first chamber and at least one second chamber positioned further away from the heat sink than the at least one first chamber. Each of the at least one first chamber and each of the at least one second chamber may be at least partially filled with a phase change material.

### BACKGROUND

### Technical Field

The present disclosure relates to a cooling device, specifically a cooling device configured to cool a lighting device. The present disclosure also relates to a motor vehicle.

### Description of the Related Art

Motor vehicles regularly have headlights to illuminate the roadway and increase visibility for others. To increase luminosity and/or provide modern lighting features that, for example, enable the display of a specific light signature, headlights are becoming increasingly more complex and powerful. Cooling such headlights is therefore becoming increasingly important.

In the prior art, cooling fins are commonly provided on the headlights for cooling purposes. However, these cooling fins offer only limited cooling performance, which is sometimes insufficient for high-performance headlights. Furthermore, the cooling fins can be replaced with active water cooling, which enables greater cooling performance, at a comparatively high cost and with a considerable increase in complexity.

In order to achieve improved cooling performance even without active water cooling, the use of phase change material (“PCM”) is known in the prior art. PCM may also be referred to as latent heat storage and makes it possible to absorb large amounts of thermal energy during a phase change. For example, U.S. Patent Application Publication No. 2011/0303946 A1 discloses an LED light on which multiple containers of phase change material are provided. Due to a phase transition of the phase change material, a larger amount of thermal energy can be dissipated from the LED light using the containers than with conventional cooling ribs. The use of phase change material for cooling purposes, in this case for cooling a projection device for a motor vehicle, is also known from EP4083703A1.

### BRIEF SUMMARY

The present disclosure provides a cooling device of the type mentioned at the outset in which each cooling fin has at least one first chamber and at least one second chamber which is further away from the heat sink than the first chamber, wherein each chamber is at least partially filled with a phase change material.

The cooling device may comprise a heat sink with a heat-conducting surface, via which heat from a heat source may be absorbed directly or indirectly. On the side facing away from the heat-conducting surface, the cooling device may have a plurality of cooling fins, which may be plate-or rib-shaped and may be arranged parallel to one another. The plurality of cooling fins may project vertically from the heat sink, but may project at a different angle. A particularly large amount of thermal energy may be absorbed by the chambers of the cooling fins, which may at least be partially filled with the phase change material. In contrast to the prior art, the cooling fins, according to the present disclosure, may have two or more chambers, each with different spacing from the heat sink, which may at least be partially filled with a phase change material, which offers advantages in terms of cooling.

Due to different spacing between the chambers and the heat sink, it is possible that, when heat absorption via the heat-conducting surface is lower, initially only the phase change material of the first chambers of the cooling fins, which are positioned closer to the heat-conducting surface than the second chamber, is used for cooling. When heat absorption is greater, i.e., when a thermal load is higher, the phase change material of the second chambers of the cooling fins may also be used for cooling, as the cooling fins then may rise in temperature in this area as well, as the heat may no longer solely be absorbed via the first chamber or dissipated in this area. This means that a type of cascading is possible, which may enable only the phase change material of the first chambers to be used when thermal load is lower, for example during normal operation of a headlight. If the heat input into the heat sink increases, so that in addition to the first chambers, the second chambers, which are further away from the heat sink and the heat source, are also subjected to sufficiently high thermal load, the phase change material of the second chambers may also be used for cooling as an overload protection. Temporary temperature peaks may be particularly well absorbed or compensated by the phase change material of the second chambers.

Overall, the cooling device may thus enable improved cooling, which may be better tailored to the heat source to be cooled. For this purpose, the spacing between the chambers of each cooling fin and the heat sink may be suitably chosen. In addition to the first chamber and the second chamber, each cooling fin may also have additional chambers which may also be at least partially filled with phase change material and, in turn, be further away from the heat sink than the second chambers. For each additional chamber, spacing from the heat sink may increase. In addition, each cooling fin may have a plurality of first chambers and/or a plurality of second chambers and/or a plurality of additional chambers.

The spacing between the first and the second chamber and the heat sink may vary for a plurality of cooling fins. For example, at least a portion of the first chamber of a first cooling fin and at least a portion of the second chamber of a second cooling fin may be equidistant from the heat sink, so that the chambers overlap parallel to the heat sink.

The heat sink may have any shape, such as a rectangular shape. The heat-conducting surface may also have any shape. For example, the heat-conducting surface may be a flat surface or a curved, three-dimensional surface. The chambers may also have any cross section. The chambers may have a rectangular, round, elliptical, or hexagonal cross section. The chambers may have a greater extent in a longitudinal direction in which the cooling fins extend away from the heat sink than in a direction parallel to the heat sink. The chambers may also taper in the longitudinal direction away from the heat sink.

Any common phase change material may be used as the phase change material, including water or a mixture of water and glycol. The chambers may be completely or partially filled with phase change material. The latter may be advantageous because it may enable volume changes in the phase change material that may occur during a phase transition to be compensated.

In some embodiments, one or more cooling fins in the first chamber may have a first phase change material, and one or more cooling fins in the second chamber may have a second phase change material. In other words, the phase change material in the first chamber and the second chamber of individual, a plurality of, or all cooling fins may differ. In some embodiments, the first phase change material and the second phase change material may have different phase transition temperatures. Such a configuration may enable the staged cooling, which may already be present due to the different spacing between the chambers and the heat sink, to be further improved. The cooling device thus may enable a particularly high degree of adjustability.

In some embodiments, the phase transition temperature of the second phase change material may be higher than that of the first phase change material. Such a configuration may enable the first phase change material to undergo a phase change or transition even at lower thermal loads, thereby contributing more to cooling, whereas the phase change of the second phase change material may require a higher thermal load. In other words, not only may the heat have to reach the second chambers further away from the heat sink, but more heat may also be required overall for the second phase change material to effectively contribute to cooling. Such a configuration may enable effective thermal overload protection. The difference between the phase transition temperatures of the phase change materials of each cooling fin may be adjusted as needed. The difference between the phase transition temperatures of the phase change materials of each cooling fin may indicate when the overload protection provided by the second phase change material becomes active.

In some embodiments, all phase change materials may be chosen so that the phase change materials may undergo two phase transitions during cooling, that is to say from “solid” to “liquid” and from “liquid” to “gaseous.” Such a configuration may enable a particularly large amount of heat to be absorbed.

If the cooling device comprises cooling fins that have additional chambers in addition to the first chamber and the second chamber, a different phase change material or the first or second phase change material may be provided in each of these additional chambers. All phase change materials may differ in their respective phase transition temperatures. Of course, a plurality of the chambers may also be filled with the same phase change material.

The cooling fins may comprise metal or plastic. Aluminum may be used as the metal. High-density polyethylene (HDPE) and polyethylene terephthalate (PET) may be used as plastics. In principle, however, any material may be suitable for producing the cooling fins, preferably one with high thermal conductivity and sufficient thermal stability for the specific application. To reduce the likelihood of damage, such as bending of the cooling fins, the cooling fins may comprise a high-strength material.

With regard to the structure of the cooling fins, one or more, and in some embodiments all, cooling fins may each be constructed from at least two interconnected cooling fin semi-finished products, wherein the first chamber and the second chamber each form a hollow space which the at least two cooling fin semi-finished products jointly enclose in the connected state. By producing the cooling fin semi-finished products and subsequently joining or connecting the cooling fin semi-finished products, the cooling fins may be produced simply and economically. In some embodiments, each cooling fin may comprise at least two mirror-symmetrically curved, such as trough-shaped, cooling fin semi-finished products. These cooling fin semi-finished products may also be understood as half-shells.

The cross section of the cooling fin semi-finished products may vary in an axial direction or remain constant. In embodiments in which the cross section of the cooling fin semi-finished products vary in the axial direction, the cooling fins may each be made from just two cooling fin semi-finished products. In embodiments in which the cross section of the cooling fin semi-finished products remain constant in the axial direction, the chambers of each cooling fin may be delimited, for example, perpendicular to the axial direction by two connected half-shells with a constant cross section and open on both sides in the axial direction. The cooling fins may then have two or more additional cooling fin semi-finished products that close the chambers at the axial ends as closure elements.

Depending on the material of the cooling fin semi-finished products, different production and joining methods may be utilized. Metallic cooling fin semi-finished products may be produced, for example, by punching or deep drawing. Plastic cooling fin semi-finished products may be produced, for example, by injection molding. The cooling fin semi-finished products may be joined by a material bond, such as by welding, gluing, or soldering, or by form-fitting and/or force-fitting, such as by flanging or roll bonding. Additional connecting elements, such as screws or rivets, may also be used. As an alternative to the multi-part construction, the cooling fins may also be produced as a single piece, for example using additive manufacturing.

To fill and/or empty its chambers, each cooling fin may have at least one closable inlet opening and/or at least one closable outlet opening. These openings may conveniently enable the chambers to be easily filled and/or emptied after the cooling fins or cooling device have been manufactured, simplifying production. The openings may also enable easy replacement of the phase change material, for example, during maintenance. Conveniently, all inlet and outlet openings may be closable in a liquid-tight and gas-tight manner to prevent accidental escape of the phase change material from the chambers.

The cooling fins may have at least one inlet opening and/or at least one outlet opening on each chamber. These openings may be provided on a side surface or on an end surface of the respective cooling fin. The cooling device may also have at least one inlet structure and/or at least one outlet structure that comprises at least a portion of the inlet openings and/or the outlet openings.

The phase change material may be filled into the chambers in any state of matter, including as a solid, such as by way of the inlet opening(s). The same applies to emptying of the chambers, such as by way of the outlet opening(s). If the phase change material is filled into the cooling fin chambers during production, the inlet and outlet openings may be omitted entirely.

In some embodiments, each cooling fin may have a wall thickness of at least 0.1 mm to 2.5 mm between an outer surface which delimits the respective cooling fin to the outside, and each chamber. The wall of each cooling fin around chambers thereof may therefore be 0.1 mm to 2.5 mm thick. Even in the wall regions that do not directly border a chamber, for example, between the first chamber and the second chamber, each cooling fin may have a corresponding or even greater wall thickness, which may be twice as thick.

The wall thickness may vary depending on the material. A low wall thickness may enable a large chamber volume and accommodation of a large amount of phase change material. The wall is sufficiently thick to provide the required strength.

In some embodiments, the cooling device may have at least one pair of cooling fins, wherein the pair of cooling fins comprises two cooling fins which are, in some embodiments, arranged parallel to one another and which are firmly interconnected by a connecting section, such as a U-shaped connecting section. Thus, two cooling fins may be combined to form a pair cooling fins and connected to form a respective connecting section. Such a configuration may significantly simplify handling during production because only the pairs of cooling fin need to be handled, rather than each cooling fin individually.

The connecting section may be an additional semi-finished product or may be formed by a region of one or more cooling fin semi-finished products. In some embodiments, the cooling fins of a pair of cooling fins are made of two mirror-image cooling fin semi-finished products that are bent into a U-shape, such that the cooling fin semi-finished products may be bent in the center. The bent region may form the connecting section.

In some embodiments, the cooling device may have a plurality of cooling fin groups, each comprising three or more cooling fins interconnected by a respective connecting section, and the cooling fins may run parallel to one another.

The cooling fins and/or the pairs of cooling fin may be fixed to the heat sink as prefabricated components. Such a configuration may facilitate the production of the cooling device. The cooling fin pairs may be fixed to the heat sink by the respective connecting section. Here, too, any joining method, with or without additional fastening devices, may be employed. Thus, the cooling fins and/or the pairs of cooling fin may be fixed to the heat sink by welding, soldering, gluing, plugging, or crimping.

The cooling fins and/or the pairs of cooling fins may be fixed to the heat sink such that there is a sufficiently large gap between each two adjacent cooling fins to prevent mutual contact between the cooling fins in the event of temperature-related expansion of the cooling fins. For this purpose, a correspondingly large gap may also be provided between the cooling fins of each pair of cooling fins. Such a configuration may prevent the cooling fins from bending one another due to lack of space.

The cooling device may additionally have one or more cooling ribs projecting from the heat sink on a side of the heat sink facing away from the heat-conducting surface. The additional cooling rib(s) may enable the heat dissipation or cooling effect enabled by the cooling device to be adjusted even more precisely.

The cooling ribs, or at least one of them, may have only one chamber at least partially filled with a phase change material. That is to say, the cooling device may also comprise cooling ribs, each of which has only one chamber with a phase change material. Additionally or alternatively, the cooling ribs, or at least one of them, may form a solid body. In other words, at least one conventional cooling rib forming a solid body may also be provided, which does not have any chambers with phase change material.

In addition to the cooling device, the present disclosure also relates to a lighting device for a motor vehicle, having at least one lighting mechanism and at least one cooling device according to the present disclosure, wherein each cooling device may be connected to one or more, or all, lighting mechanisms in a heat-conducting manner via the respective heat-conducting surface either directly by the heat-conducting surface abutting the respective one or more lighting mechanisms or indirectly, such as via an additional heat-conducting device. The cooling device according to the present disclosure may improve cooling of one or more lighting mechanism, including high-performance lighting mechanisms. All features and advantages described in connection with the cooling device according to the present disclosure also apply to the lighting device according to the present disclosure, and vice versa.

The at least one cooling device may be thermally coupled to the one or more lighting mechanisms via thermally conductive surface(s) thereof through direct physical contact. Alternatively, the at least one cooling device may be thermally coupled to the one or more lighting mechanism indirectly through the heat-conducting devices, such as a thermally conductive paste.

The lighting device may be a headlight, such as an LED headlight. Additionally or alternatively, the at least one lighting mechanisms may be configured to provide a low beam. The lighting device may be a headlight, such as a motor vehicle headlight, which has multiple high-performance LED lighting mechanisms. The cooling device may ensure effective cooling of the LED lighting mechanisms, even when significant heat is generated. The lighting device may also be a rear light or any other light, such as high-performance lights or a rotating beacon, of a motor vehicle.

Finally, the present disclosure also relates to a motor vehicle having at least one cooling device according to the present disclosure and/or at least one lighting device according to the present disclosure. The features and advantages mentioned above with regard to the cooling device according to the present disclosure and the lighting device according to the present disclosure also apply to the motor vehicle according to the present disclosure, and vice versa. The motor vehicle may have two high-performance headlights, such as matrix LED headlights, each with a plurality of high-performance LED lighting mechanisms, as lighting devices, as well as one or more cooling devices according to the present disclosure for cooling the LED lighting mechanisms.

BRIEF DESCRIPTION OF THE SEVERAL VIEWS OF THE DRAWINGS

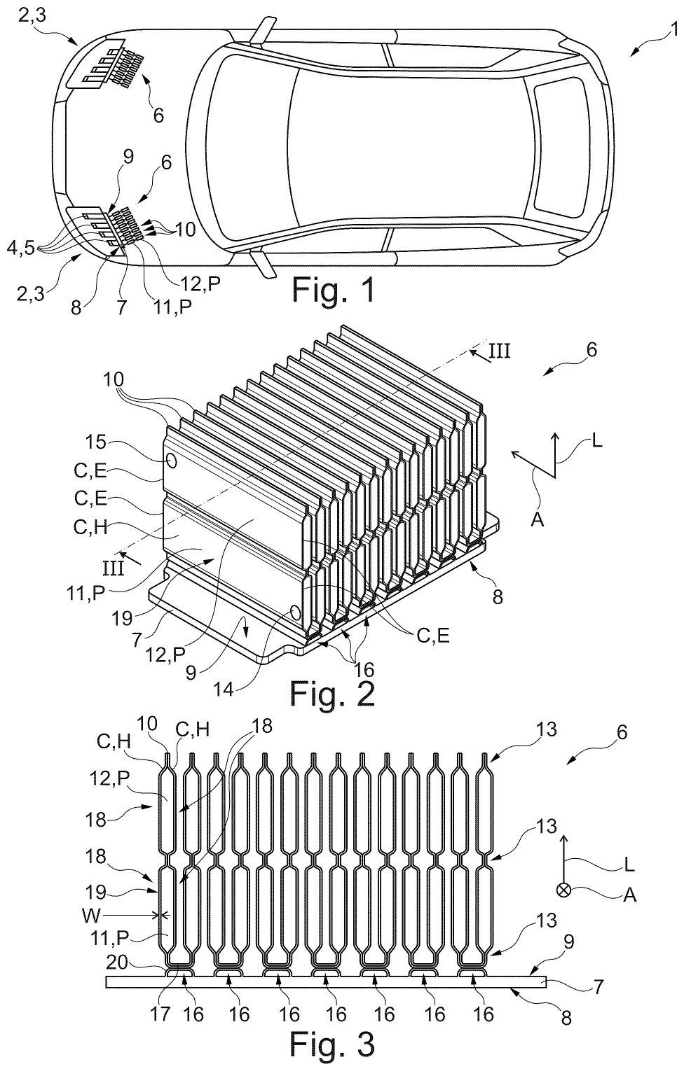

FIG. 1 shows a plan view of an exemplary embodiment of a motor vehicle according to the present disclosure with a lighting device according to the present disclosure.

FIG. 2 shows a perspective view of a cooling device of the lighting device of FIG. 1.

FIG. 3 shows a cross-sectional side view of the cooling device of FIG. 2.

### DETAILED DESCRIPTION

FIG. 1 shows, in the form of a plan view, an exemplary embodiment of a motor vehicle 1 according to the present disclosure with two structurally identical lighting devices 2 according to the present disclosure, which are provided as headlights 3, specifically as matrix LED headlights. Each headlight 3 may have a plurality of high-performance lighting mechanisms 4 in the form of LEDs 5, which may be configured to generate or provide a low beam in a standard operating mode and a high beam in a power operating mode. For cooling lighting mechanisms 4, each lighting device 2 may comprise a cooling device 6 according to the present disclosure. This is shown schematically in FIG. 1. FIGS. 2 and 3 show cooling device 6 in detail as a perspective view (FIG. 2) and as a cross-sectional view (FIG. 3) along the line III-III.

As shown in Figures. 2 and 3, cooling device 6 may comprise a heat sink 7 with a heat-conducting surface 8 and a plurality of cooling fins 10 arranged parallel to one another on a side 9 of heat sink 7 opposite heat-conducting surface 8 and projecting from heat sink 7 along a longitudinal axis L. Each of said cooling fins 10 may have a first chamber 11 and a second chamber 12, wherein second chamber 12 is further away from heat sink 7 than first chamber 11, and wherein both chambers 11, 12 may be almost completely filled with a phase change material P. Heat sink 7 may also have a plurality of heat-conducting surfaces 8, which may be spatially separated heat-conducting surfaces 8.

In FIG. 1, cooling devices 6 may be installed in lighting devices 2 such that the heat-conducting surface 8 directly abuts respective lighting mechanisms 4, thus physically touching the cooling devices 6 and the respective lighting mechanisms 4 and thus thermally coupling the cooling devices 6 to lighting mechanisms 4. A heat-conducting device, such as a thermally conductive paste, also be provided between lighting mechanism 4 and heat-conducting surface 8 for thermal coupling.

Due to the phase change material P in chambers 11, 12, which may be a mixture of water and glycol that can undergo two phase changes for cooling, cooling device 6 may enable a cooling performance that is significantly improved compared to conventional cooling ribs. Because second chambers 12 are farther away from the heat source formed by lighting mechanism 4, a staged cooling effect of cooling device 6 may be achieved.

If, in FIG. 1, lighting mechanisms 4 accumulate less heat in standard operating mode than in power operating mode, cooling may be effected solely or at least predominantly via first chambers 11, for example through a phase change of phase change material P provided therein. If more heat is absorbed by cooling device 6 in power operating mode of lighting mechanisms 4, part of the cooling may also be effected via second chambers 12. The heat may then also be absorbed by phase change material P provided in more distant, second chambers 12. Second chambers 12 therefore may primarily serve for cooling in special load conditions, i.e., as a type of overload protection when the cooling effect by first chambers 11 is no longer sufficient.

In order to achieve a particularly good cooling effect with cooling device 6, first chambers 11 may have a first phase change material P and second chambers 12 may have a second phase change material P, wherein first phase change material P may have a lower phase transition temperature than second phase change material P. This offers the advantage that first phase change material P, in contrast to second phase change material P, may undergo a phase transition much earlier, i.e., with lower heat absorption. Based on the difference in the phase transition temperatures of the two phase change materials P, staging of the cooling effect of cooling device 6 may be adjusted particularly precisely. Such a configuration may enable specification of the heat absorption level at which second chambers 12 make a significant contribution to cooling.

As shown in the example embodiment of FIGS. 2 and 3, each cooling fin 10 may be constructed from six interconnected cooling fin semi-finished products C, which together enclose respective chambers 11, 12. Two of these cooling fin semi-finished products C may be mirror-image half-shells H with recesses 18 (see FIG. 3), which, after mutual joining, laterally delimit chambers 11, 12. Four end pieces E may be provided as additional cooling fin semi-finished products C (see FIG. 2), which also close chambers 11, 12 in an axial direction A.

In the embodiment shown in the figures, the cooling fins are made of aluminum by way of roll-bonding, which may enable particularly cost-effective manufacture. The cooling fins may also comprise a plastic with good thermal conductivity, such as, for example, high-density polyethylene (“HDPE”) or polyethylene terephthalate (“PET”).

Each cooling fin 10 may have a wall thickness W of 1.5 mm between an outer surface 19 delimiting cooling fin 10 and each of its chambers 11, 12. Such a wall thickness W may enable a large volume of chambers 11, 12 and consequently the accommodation of a large amount of phase change material P, which increases the cooling performance. At the same time, the walls of cooling fins 10 may be sufficiently thick to provide good stability. Depending on the material and production method, the minimum wall thickness W may be between 0.1 mm and 2.5 mm. In intermediate regions 13 that do not directly adjoin chambers 11, 12, cooling fins 10 may have a greater wall thickness W of, for example, 3 mm to 8 mm.

To fill and empty chambers 11, 12 with phase change material P, cooling fins 10 may have an inlet opening 14 and an outlet opening 15 on each of their chambers 11, 12, which may be closable in a liquid-tight and gas-tight manner and allow chambers 11, 12 to be filled with phase change material P only after cooling fins 10 or cooling device 6 have been manufactured, which may simplify production. Phase change material P may also be readily replaced. During filling and emptying, phase change material P may be in any state of matter.

In some embodiments, cooling fins 10 may not be individually fixed to heat sink 7. Instead, a plurality of pairs of cooling fins 16 may be provided, each having two cooling fins 10 that may be firmly interconnected by a U-shaped, curved connecting section 17. Such a configuration may facilitate handling and may reduce the number of necessary joints on heat sink 7. Furthermore, to facilitate the attachment of the pairs of cooling fin 16, heat sink 7 may comprise local elevations 20 to which pairs of cooling fins 16 may be firmly fixed via their respective connecting section 17. Here, too, any suitable connection technology may be utilized, including welding, soldering, gluing, plugging, or crimping.

Pairs of cooling fins 16 may be fixed to heat sink 7 as prefabricated components, which may simplify the production of cooling device 6. All cooling fins 10 may be arranged such that there is a free space between each two adjacent cooling fins 10 that is sufficiently large to prevent adjacent cooling fins 10 from touching each other during temperature-induced expansion and possibly bending or damaging each other.

In some embodiments, cooling device 6, such as those on side 9, may additionally have one or more cooling ribs projecting from heat sink 7. These cooling ribs may be conventional cooling ribs forming a solid body. However, the cooling ribs may also have only one chamber that is at least partially filled with a phase change material P. With appropriate cooling ribs, the cooling performance of cooling device 6 may be adjusted even more precisely to the respective application.

Cooling device 6 may also be provided for cooling rear lights 13 or any other lighting devices 2 of motor vehicle 1 of FIG. 1. Each lighting device 2 may also comprise a plurality of cooling devices 6, each of which cools only a portion of lighting mechanisms 4.

German patent application no. 102024123753.8, filed Aug. 20, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A cooling device comprising:
a heat sink having at least one heat-conducting surface, the heat sink configured to be coupled to a heat source in a heat-conducting manner; and
at least two cooling fins projecting from the heat sink on a side of the heat sink facing away from a heat-conducting surface of the at least one heat-conducting surface,
wherein each cooling fin of the at least two cooling fins includes at least one first chamber and at least one second chamber positioned further away from the heat sink than the at least one first chamber, each of the at least one first chamber and each of the at least one second chamber being at least partially filled with a phase change material.

2. The cooling device according to claim 1, wherein one or more cooling fins of the at least two cooling fins include a first phase change material in a first chamber of the respective at least one first chamber and one or more cooling fins of the at least two cooling fins include a second phase change material in a second chamber of the respective at least one second chamber,
wherein the first phase change material includes a first phase transition temperature and the second phase change material includes a second phase transition temperature, the first phase transition temperature differing from the second phase transition temperature.

3. The cooling device according to claim 2, wherein the second phase transition temperature is higher than the first phase transition temperature.

4. The cooling device according to claim 1, wherein one or more cooling fins of the at least two cooling fins are each constructed from at least two interconnected cooling fin semi-finished products, and
wherein the at least one first chamber and the at least one second chamber of each of the one or more cooling fins each form a hollow space enclosed by the at least two cooling fin semi-finished products when the at least two cooling fin semi-finished products are in a connected state.

5. The cooling device according to claim 4, wherein each of the at least two cooling fins are constructed from at least two interconnected cooling fin semi-finished products.

6. The cooling device according to claim 1, wherein the at least two cooling fins comprise a metal or a plastic.

7. The cooling device according to claim 1, wherein each cooling fin of the at least two cooling fins has a wall thickness of between 0.1 mm and 2.5 mm, the wall thickness being a thickness between an outer surface delimiting an outside of the respective cooling fin and each of the at least one first chamber and the at least one second chamber of the respective cooling fin.

8. The cooling device according to claim 1, wherein each cooling fin of the at least two cooling fins includes at least one closable inlet opening and/or at least one closable outlet opening, the at least one closable inlet opening configured for filling the at least one first chamber and the at least one second chamber of the respective cooling fin, the at least one closable outlet opening configured for emptying the at least one first chamber and the at least one second chamber of the respective cooling fin.

9. The cooling device according to claim 8, wherein each of the at least one first chamber and each of the at least one second chamber of each cooling fin of the at least two cooling fins includes at least one closable inlet opening and/or at least one closable outlet opening.

10. The cooling device according to claim 1, wherein at least one pair of cooling fins of the at least two cooling fins are arranged parallel to one another and interconnected by a connecting section.

11. The cooling device according to claim 10, wherein the connecting section is a U-shaped connecting section.

12. The cooling device according to claim 1, wherein the at least two cooling fins are fixed to the heat sink as prefabricated components.

13. The cooling device according to claim 1, further comprising one or more cooling ribs projecting from the heat sink on the side of the heat sink facing away from the heat-conducting surface,
wherein at least one of the one or more cooling ribs includes only one chamber at least partially filled with a phase change material and/or wherein at least one of the one or more cooling ribs forms a solid body.

14. A lighting device for a motor vehicle comprising:
at least one lighting mechanism; and
at least one cooling device, each cooling device of the at least one cooling device including:
a heat sink having at least one heat-conducting surface, the heat sink configured to be coupled to a heat source in a heat-conducting manner; and
at least two cooling fins projecting from the heat sink on a side of the heat sink facing away from a heat-conducting surface of the at least one heat-conducting surface,
wherein each cooling fin of the at least two cooling fins includes at least one first chamber and at least one second chamber positioned further away from the heat sink than the first chamber, each of the at least one first chamber and each of the at least one second chamber being at least partially filled with a phase change material,
wherein each cooling device is connected to one or more lighting mechanisms of the at least one lighting mechanism in a heat-conducting manner via the respective at least one heat-conducting surface either directly by the respective at least one heat-conducting surface abutting the respective one or more lighting mechanism or indirectly.

15. The lighting device according to claim 14, wherein each cooling device is connected to all lighting mechanisms of the at least one lighting mechanism in a heat-conducting manner via the respective at least one heat-conducting surface.

16. The lighting device according to claim 14, wherein each cooling device is connected to the one or more lighting mechanisms in a heat-conducting manner via the respective at least one heat-conducting surface indirectly via an additional heat-conducting device.

17. The lighting device according to claim 14, wherein the lighting device is a headlight, and/or the at least one lighting mechanism is configured to provide a low beam.

18. The lighting device according to claim 17, wherein the lighting device is an LED headlight.

19. A motor vehicle comprising:
at least one cooling device, each cooling device of the at least one cooling device including:
a heat sink having at least one heat-conducting surface, the heat sink configured to be coupled to a heat source in a heat-conducting manner; and
at least two cooling fins projecting from the heat sink on a side of the heat sink facing away from a heat-conducting surface of the at least one heat-conducting surface,
wherein each cooling fin of the at least two cooling fins includes at least one first chamber and at least one second chamber positioned further away from the heat sink than the first chamber, each of the at least one first chamber and each of the at least one second chamber being at least partially filled with a phase change material; and/or
at least one lighting device, each lighting device of the at least one lighting device including:
at least one lighting mechanism; and
one or more cooling devices of the at least one cooling device,
wherein each cooling device is connected to one or more lighting mechanisms of the at least one lighting mechanism in a heat-conducting manner via the respective at least one heat-conducting surface either directly by the respective at least one heat-conducting surface abutting the respective one or more lighting mechanism or indirectly.
